(19) United States
(12) Patent Application Publication
(10) Pub. No.: US 2015/0243186 A1
(43) Pub. Date: Aug. 27, 2015

(54) Method For Facilitating Menu Planning

(71) Applicant: Thrive 365 International, Inc., Westford, MA (US)

(72) Inventors: Keith R. Eberhardt, Succasunna, NJ (US); Nathan V. Matusheski, East Hanover, NJ (US); Kristin H. Rubin, Glenview, IL (US); Arlene O. Sanoy, Chicago, IL (US)

(21) Appl. No.: 14/432,009

(22) PCT Filed: Sep. 27, 2013
(86) PCT No.: PCT/US13/62127

§ 371 Date: Mar. 27, 2015

Related U.S. Application Data
(60) Provisional application No. 61/707,407, filed on Sep. 28, 2012.

(51) Int. Cl. G09B 19/00; G06F 19/00; A23L 1/29

(52) U.S. Cl. CPC G09B 19/0092; A23L 1/293; G06F 19/3475; A23V 2002/00

(57) ABSTRACT

A method and system have been developed whereby one or more nutrients of concern may be tracked individually while also tracking the overall or composite nutritional score for one or more meals. In this regard, the composite score may be based on a relatively easy to follow system, such as a simple point based system. Furthermore, the nutrient of concern may also be tracked using a simple method, such as by the use of the intensity, hue and/or luminosity of colors. In this regard, a food product can include a composite score number and also color intensity for one or more nutrients of concern.

### CROSS-REFERENCE To RELATED APPLICATION

This application claims the benefit of U.S. Provisional Application No. 61/707,407, filed Sep. 28, 2012, which is hereby incorporated herein by reference in its entirety.

### FIELD

This present application is directed to a method and system for facilitating menu planning, and more specifically, to menu planning and tracking one or more nutrients of concern along with an overall composite nutritional score for a single meal and/or a number of cumulative meals.

### BACKGROUND

Consumers are often interested in making healthy food choices. Many consumers need to make food choices that will help them maintain a diet for various health related reasons. For example, there are significant health advantages in keeping blood glucose levels (equivalently, blood glucose concentrations) within certain limits. Excessively high blood glucose levels (hyperglycemia) have been implicated in the breakdown of capillaries (such as within the retina) and in kidney damage. The damage is possibly due to the formation of polysaccharides such as sorbitol, as discussed for example in U.S. Pat. No. 6,074,822. Low blood glucose (hypoglycemia) can lead to feelings of dizziness, nausea, extreme hunger, poor decision making, and the breakdown of diet programs. Hypoglycemia is also dangerous for people operating equipment.

Currently, patients suffering from diabetes or even individuals who are trying to eat a healthy diet, are either instructed to follow a complex diet exchange system or count carbohydrates or calories. These systems tend to be difficult and frustrating for individuals to follow. The resulting difficulty and frustration often causes people to not follow and maintain a desired diet.

Similarly, other consumers also have to carefully track other nutrients of concern such as fats, sodium, potassium and the like. Examples of such nutrients include monitoring saturated fat intake for an individual with cardiovascular disease, and potassium intake for an individual on dialysis. In these situations, overall diet quality also needs to be maintained, thus meal planning can be tedious. Simplified diet planning systems have been developed that calculate a single composite value, score or point level for each food serving in a diet. Such methods have been used for identification of healthier foods, and menu planning to address overall health concerns and weight management. However, a limitation of such systems is that one or more single nutrients of concern cannot be readily isolated from the composite score. Therefore, individuals that need to maintain lower and/or higher intake of certain nutrients of concern cannot use such systems without having to independently track the nutrients, thereby complicating the systems.

### SUMMARY

A method and system have been developed whereby one or more nutrients of concern may be tracked individually while also tracking the overall or composite nutritional score for one or more meals. In this regard, the composite score may be based on a relatively easy to follow system, such as a simple point based system. Furthermore, the nutrient of concern may also be tracked using a simple method, such as by the use of the intensity of colors. In this regard, a food product can include a composite score number and also color intensity for one or more nutrients of concern. Color hue, saturation and luminosity are used to help a user quickly identify the most suitable foods by reflecting the content of a particular nutrient and combine foods to create a meal that meets a target value. Similarly, a system has been developed whereby the composite scores and nutrients of concern may be tracked easily and may also be used to provide guidance to a user in developing a meal plan for one or more meals.

In one form, a method for determining a comestible's suitability for a nutrition program is provided. The method includes the steps of: determining a plurality of nutritional attributes per serving for a comestible, the nutritional attributes selected from the group consisting of calories, fat, fiber, protein, salt, and carbohydrates; calculating a composite score for the comestible based on the plurality of nutritional attributes, the composite score providing a quantitative indicator of the nutrition of the comestible; determining an amount of a nutrient of concern per serving of the comestible; comparing the amount of the nutrient of concern per serving to an overall intake limit of the nutrient of concern for the nutritional program to select an indicia from a range of indicia for the nutrient of concern; and providing the composite score and the indicia for the nutrient of concern for the comestible.

According to one form, a method for selecting foods suitable for a nutrition program is provided. The method includes the steps of, by a control circuit: receiving an identification of a first comestible and a number of servings of the first comestible from a user; providing a first composite score reflecting a plurality of nutritional attributes for the first comestible for the number of servings; providing a first indicia for a nutrient of concern, the first indicia representing the relative amount of the nutrient of concern in the first comestible compared to an overall intake limit of the nutrient of concern in the nutrition program; receiving an identification of a second comestible and a number of servings of the second comestible from the user; providing an overall composite score reflecting a total of the nutritional attributes for the number of servings of the first and second comestibles; and providing an overall indicia for the nutrient of concern, the overall indicia representing the relative total amount of the nutrient of concern in the servings of the first and second comestibles compared to the overall intake limit of the nutrient of concern in the nutrition program.

In another form, a method for selecting foods suitable for a nutrition program is provided. The method includes the steps of, by a control circuit: receiving an identification of a first comestible and a number of servings of the first comestible from a user; providing a first composite score reflecting a plurality of nutritional attributes for the first comestible for the number of servings; providing a first indicia for a nutrient of concern, the first indicia representing the relative amount of the nutrient of concern in the first comestible compared to an overall intake limit of the nutrient of concern in the nutrition program; providing a suggestion of at least one additional comestible and a number of servings of the at least one additional comestible to the user, the total amount of the nutrient of concern in the servings of the first comestible and the servings of the at least one additional comestible falling within an acceptable range for the nutrition program; providing an overall composite score reflecting a total of the nutritional attributes for the number of servings of the first comestibles and the at least one additional comestible; and providing an overall indicia for the nutrient of concern, the overall indicia representing the relative total amount of the nutrient of concern in the servings of the first and second comestibles compared to the overall intake limit of the nutrient of concern in the nutrition program.

According to one form, the indicia for the nutrient of concern for the comestible is a non-numeric indicia.

In one form, the range of indicia for the nutrient of concern includes a plurality of colors and the indicia for the nutrient of concern for the comestible is one of the plurality of colors.

In another form, the nutrient of concern is selected from the group consisting of carbohydrates, fats, potassium and sodium.

According to one form, the method further includes providing a supplemental indicia for a supplemental nutrient of concern.

In one form, the method further includes providing a suggestion of at least one additional comestible and a number of servings of the at least one additional comestible to the user, the total amount of the nutrient of concern in the servings of the first comestible, the second comestible and the at least one additional comestible failing within an acceptable range for the nutrition program.

In another form, the overall intake limit for the nutrient of concern is a limit for one of the group consisting of a meal, a day or meals and a week of meals.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a representation showing a composite score along with a nutrient of concern;

FIG. 2 is a representation of a meal planning checklist for use in managing meal planning;

FIG. 3 is a representation of settings for zero score foods;

FIG. 4 is a representation of how serving sizes impact scores for various foods;

FIG. 5 is a representation of one form of a system for selecting foods to add to a meal plan;

FIG. 6 is a representation of one form of a database of food choices;

FIG. 7 is a representation of one form of adding foods to a meal plan;

FIG. 8 is a representation of one form of a meal plan after foods and servings have been selected;

FIG. 9 is a table illustrating one form of energy choices and servings of types of foods that may be suggested to a user for meal planning; and

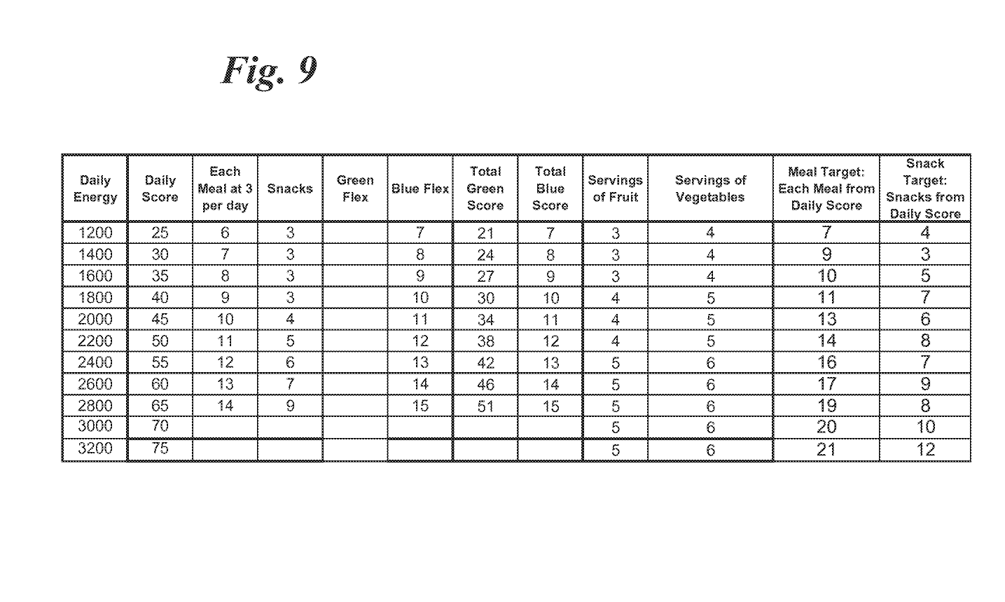

FIG. 10 is a diagram of one form of providing a composite score and indicia for a nutrient of concern for a first comestible;

FIG. 11 is a diagram of one form of providing a composite score and indicia for a nutrient of concern for a first comestible and suggesting a second comestible; and

FIG. 12 is a diagrammatic representation of one device system for providing a composite score and indicia for a nutrient of concern.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally, a variety of methods and associated systems are described herein for planning meals by tracking an overall composite nutrition score and a nutrient of concern. By one approach, the system and method may utilize non-nuermic indicia, such as color, to help track and guide a user regarding a nutrient of concern and to facilitate the menu planning of a user. Such a system could be used on a website, mobile phone or computer application for simplified diet planning that addresses the needs of a user with a specific nutrient of concern.

Such a system and method differs substantially from current techniques for diet planning. For example, one major distinction is that this system and method enable the use of both a composite nutrition score and also a nutrient of concern in diet planning. A second major distinction is that color hue and intensity (luminosity and saturation) may be used as readily identifiable indicia to facilitate the identification of food items that can meet specific criteria for a nutrient of concern for a user while also maintaining a desired overall nutrition. A third major distinction is that the color hue and saturation may change dynamically to guide the user to select choices that more easily meet their meal or daily targets for the nutrient of concern.

A system and method have been developed to facilitate the tracking of a nutrient of concern alongside a composite nutrition score, enabling the user to plan meals that meet both and nutrition score target and also a target for a nutrient of concern. A composite nutrition score was calculated for a database of foods as described in more detail below. An electronic menu planning system was then developed to enable users to search for, select and plan meals that meet a scoring criteria (e.g., 10 units per meal).

A nutrient of concern, such as carbohydrates, is displayed alongside scoring data, and additionally the food selections were displayed with varying color luminosity to represent the varying amounts of the nutrient of concern to enable a user to quickly identify a food that meets both a scoring criteria and a carbohydrate choice criteria. Color hue is further used to help a user achieve a meal plan target for the nutrient of concern (for example, blue=below target, green=on target, red=above target). In this way, a user can more effectively plan meals that meet both a nutrition score representing overall diet quality and a nutrient of concern.

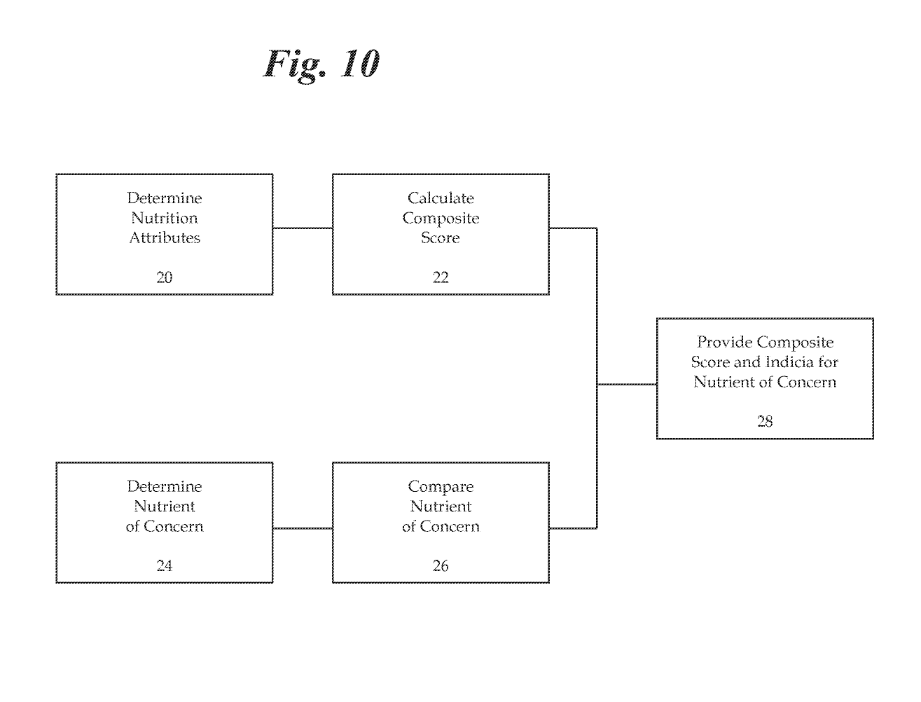

One form of the system and method will now be described with reference to FIG. 10. In this form, the nutritional attributes of a comestible are determined, such as at step 20. This may be done in a number of manners including, but not limited to, referring to a database, referring to packaging information, testing the comestible and the like. The nutritional attributes can then be used to calculate a composite score for the comestible, such as in step 22. Further, the amount of one or more nutrients of concern is determined, such as at step 24. The specific nutrient of concern and the amount of the nutrient of concern can be determined, such as by referring to a database, referring to packaging information, testing the comestible and the like. The amount of the nutrient of concern is then compared to the desired intake of the nutrient of concern, such as in step 26. This comparison may be made based on a daily intake, a meal intake, a weekly intake, a portion of one of these intakes, and/or a combination of the intake time periods. Finally, a composite score for the comestible and indicia for the nutrient of concern are provided, such as at step 28. It should be understood that these steps may be performed and/or provided in any order, such as the nutrient of concern steps being performed before, after, and/or concurrently with the composite score steps.

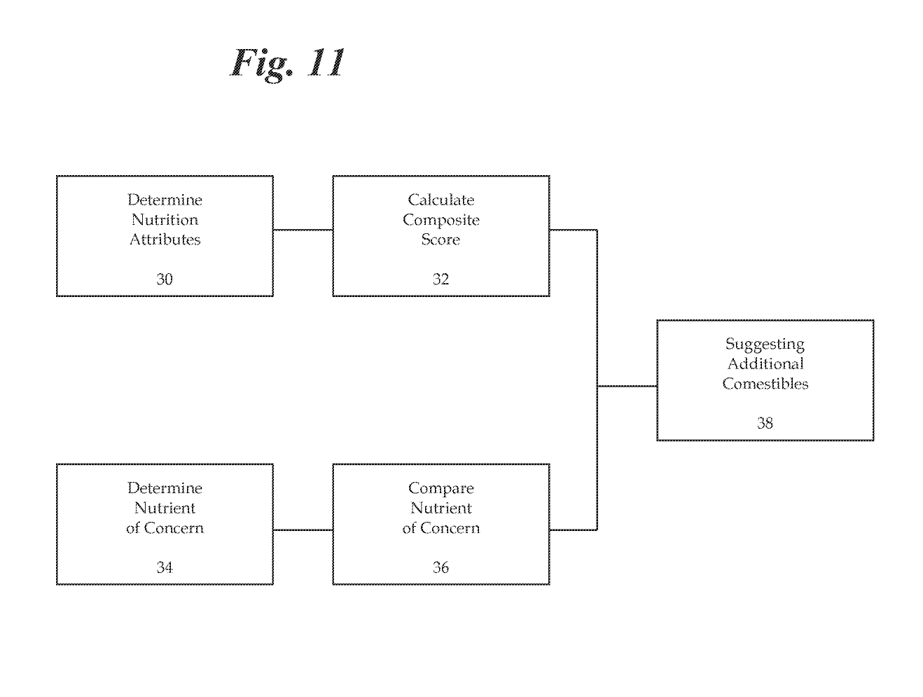

Yet another form is represented in FIG. 11. In this form, multiple comestibles are analyzed to provide information for an overall combination of comestibles and/or to suggest comestibles for achieving a desired intake. Generally, steps 30, 32, 34 and 36 are similar to steps 20, 22, 24 and 26 in FIG. 10. Further, steps 30, 32, 34 and 36 may be performed for a plurality of comestibles to provide an overall composite score and overall indicia for the nutrient of concern. Additionally, the method in FIG. 11 may be used to suggest a comestible to a user such that the overall composite score and nutrient of concern for multiple comestibles falls within a desired range. In this form, step 38 may be used to suggest a comestible falling within the desired ranges. In one form, multiple comestibles are suggested. In another form, multiple comestibles are suggested where the comestibles may have different indicia for the nutrient of concern, generally indicating the relative amounts of the nutrient of concern in each so as to help a user determine which food suggestions have more or less of the nutrient of concern. In one form, multiple food suggestions are provided and the indicia for the nutrient of concern may vary from blue to a light green to a darker green to red, thereby indicating the relative appropriateness of the suggestions for the overall meal plan.

One form of the components of the system will now be described. In one form, the system may include a control circuit, a memory and a network interface. The system may also include one or more output devices such as a printer, screen, speakers, and the like. The system also optionally includes or otherwise is operably connected to a user interface whereby a user may access the system. It should be noted that the user interface may be located remotely from the system, such as at a third party's computer, mobile phone, laptop and the like.

The system may take a variety of forms including, but not limited to, one or more servers, computers, portions of servers or computers, and the like as understood by those skilled in the art. The system may also take the form of a mobile phone, tablet, portable or other electronic device. For example, the system may be a server whereby a user may access the system via his or her mobile device. Alternatively, the system may take the form of the user's mobile device that accesses a server or database remotely or a retailer's computer system. In yet another form, the user's mobile device may operate independently to provide a composite score and indicia for a nutrient of concern without accessing a separate server or database.

The control circuit may also take a variety of forms including, but not limited to, one or more processors, hardware, software and the like. The present teachings will readily accommodate using a control circuit that comprises a dedicated-purpose hard wired platform or a partially or wholly-programmable platform as desired. The memory may also take a variety of forms including, but not limited to, one or more electronic memory units including but not limited to read-only memory (ROM), random-access memory (RAM), hard drive(s), and the like. The memory may be operably coupled to the control circuit to provide data, access to one or more databases, and other information to the control circuit. The network interface may also take a variety of forms including, but not limited to, a modern, Ethernet, Wi-Fi, cellular, satellite and other electronic communications forms. For example, the network interface may be configured to interface with a wide area network (WAN), a local area network (LAN), the Internet, SMS/MMS messaging, cellular connections, social networks and the like.

In yet another example, a small handheld barcode reader can be configured with an ability to submit a read barcode for a given food item to a database and to receive in turn information regarding the contents of that food item. This information can then be employed by the reader in conjunction with these teachings to calculate a corresponding relative score number for that food item. When this barcode reader comprises, for example, a cellular telephone or the like, the score number can be presented on the device's display to permit the end user to make use of that information when deciding, for example, whether to purchase this food item. By another approach, this barcode reader can have an integral label printer. In this case, a label could be printed with this score number. This label can then be attached to the food item. Such an approach would allow retail store employees to mark their food items in this way notwithstanding that the manufacturers of such items might otherwise eschew such a practice. The barcode reader can also be used for the nutrient of concern.

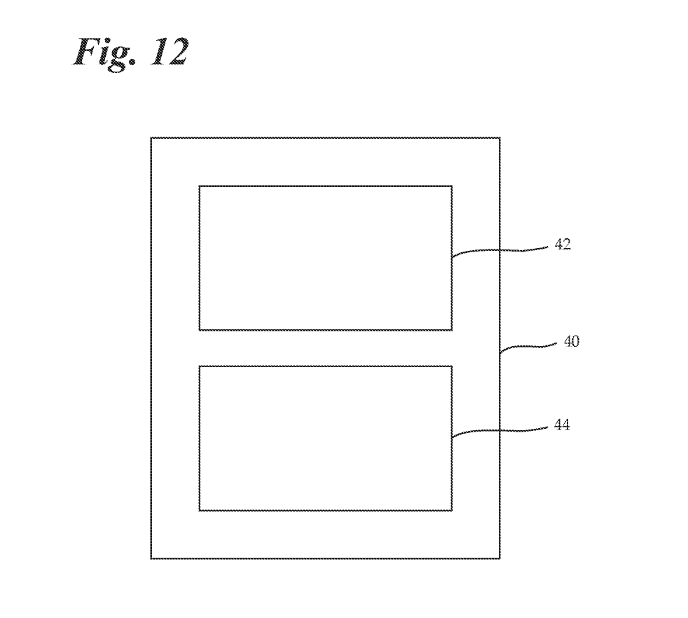

One form of a device is shown in FIG. 12. In this form, the device 40 includes an output 42 and an input 44, In one form, the output 42 may be a display, screen, printer and the like to provide a visual and/or audio presentation of information from the system. The input 44 may include any form of input suitable for inputting information about a comestible and/or a user. For example, the input 44 may include a touchscreen, keyboard, camera, barcode reader and the like. In one form, the device 40 may be a mobile phone and the output 42 and the input 44 form part of a screen or display, such as on many smartphones.

Composite Score Determination

The composite score may be calculated and determined in a number of manners, in one form, the method of determining the composite score is performed according to U.S. Publication No. 2009/0298021, the contents of which are hereby incorporated by reference.

For example, the composite score may be calculated using a predictive method whereby a forced choice comparison is used to prepare the predictive method. In one form, a panel of experts skilled in planning a specific diet effective for providing a desired result are each subject to a plurality of forced choice comparisons as discussed below.

Since an expert is likely using a variety of information about a food to make a choice, and since it is possible or even likely that two experts will differ in their choice of which information to use and the weight assigned to different pieces of information, it would be extremely difficult to obtain agreement among experts on these points. Therefore, all available information about a food, as well as information that might not be commonly known but could be known to an expert, was assumed to contribute to the decision process in the forced choice comparison. This information was captured in a data file in order that statistical analyses could be conducted to determine what information about a food could be used to most reliably and accurately predict the raw score of that food. Stepwise regression was used to develop predictive equations, with as few as 3 variables to as many as 17 variables.

Information which could potentially be used in such a regression included all information in the NFP as seen by the experts, as well as mono-unsaturated fat (g), poly-unsaturated fat (g), potassium (mg), insoluble fiber (g), soluble fiber (g), individually all B vitamins including folic acid (% DV based on a 2000 kilocalorie diet), vitamins A, D, E (% DV based on a 2000 kilocalorie diet), minerals Mg, and P, which were not seen by the experts but could have been known by the experts and so used in the decision process. Additionally, combinations of the various pieces of information were also permitted as variables in the regression analysis (e.g., saturated fat (g) plus trans fat (g), total fat (g) plus carbohydrates (g) plus protein (g); Ca (% DV) plus iron (% DV) plus vitamin A (% DV) plus vitamin C (% DV), to name a few), as were transformations of these variables (square root, natural log, exponent, and so forth).

In another aspect, the function used to calculate the raw score has the general form set forth in Equation 16A below.

RAW SCORE=k₀+k₁×f₁(x₁)+k₂×f₂(x₂)+k₃×f₃(x₃)+k₄×f₄(x₄)+k₅×f₅(x₅)+k₆×f₆(x₆)+ . . .

Where the coefficients k₀, k₁, k₂, k₃, k₄, k₅, k₆, . . . are numerical constants which can range from 0 to 50, the functions f₁, f₂, f₃, f₄, f₅, f₆, . . . are appropriate functions of the nutrient values, represented by x₁, x₂, x₃, x₄, x₅, x₆, . . . . The x₁ could also represent functions of two or more nutrient values corresponding to the food item in question.

The functional forms for f₁, f₂, f₃, f₄, f₅, f₆, . . . may include linear, logarithmic, exponential, trigonometric, splines, wavelets, and other monotone (and near monotone) functions that can be increasing or decreasing. These equations can be used to predict raw scores for foods,

Determination of a Relative Score

Raw scores represent the “appropriateness” for a food's inclusion in the diet of a person, low scoring foods can be included more readily and hence are characterizable as being more appropriate, high scoring foods less readily and hence are characterizable as being less appropriate. In addition, these equations can be applied to all foods in the diet. However, it would be extremely difficult for most individuals to keep track of the total diet score for a day if foods can be assigned scores with four significant digits and each of these scores were to be added to provide a tally for the day. Therefore, the predicted raw scores are modified to be more useful and easier to keep track of for the consumer. In. one approach, this means that the relative score of a single serving (generally a RACC, or a serving as described in a recipe, a food package or other similar means) of a food can range from zero to a maximum of seven (or eight, or nine, or ten or . . . or twenty, depending on the number of categories). These scores are now called relative scores.

Use of Composite Score

Methods for developing diet plans using the composite score are provided which utilize both the relative score and which require choices of foods from different categories. For example, one aspect of the diet plan may require the total relative score number to equal a certain number or be within a certain range for period of time, such as one day. The total relative score number is determined by adding the relative score number for each food item consumed or to be consumed during that day. In one form, the composite score is determined based on a number of nutrients as modeled in the predictive equations. For example, the composite score may be based on the amount of calories, fat, fiber, protein, salt and carbohydrates per serving. In an additional aspect of the diet plan, foods may be selected from two different categories such that certain levels of relative score number totals are achieved from selections in each food category. Food categories may be identified using any appropriate terminology.

The resultant calculated relative score number can then be displayed in some manner that is useful to the dieter. This can comprise, for example, placing the relative score number for a given food item on the container that contains that food item. The relative score may take a variety of forms. For example, in one form, the composite score is a quantitative indicator of the nutrition of the comestible. In this regard, the composite score may be a number, such as 1 through 10.

Nutrient of Concern

As mentioned above, the nutrient of concern may include any number of different nutrients that may be important to a user's diet. For example, in the case of a diabetic, the nutrient of concern would be carbohydrates. Other nutrients may include potassium, sodium, fats, and other nutrients that may be important for a particular diet or health consideration.

The overall amount of the nutrient of concern may be set by the system upon entering a particular diet or health consideration or may otherwise be entered by a user of a health professional. For example, a user may set a maximum threshold for daily carbohydrate intake or may specify a certain amount of carbohydrate intake as spread out over a period of house of the day. In another form, the system may be setup so that the nutrient of concern may have a higher loading at certain times of the day, such as during breakfast.

The nutrient of concern may be tracked using a variety of different indicia. For example, in one form, the nutrient of concern may be indicated via one or more colors. In this regard, the nutrient of concern may be indicated using luminosity and/or intensity. Other numeric and non-numeric indicia are also contemplated, such as using shapes.

An example of how a nutrient of concern may be analyzed for meal planning is described below with respect to carbohydrates. It should be understood that similar analyses may be used for other nutrients of concern.

It has been recommended that people with diabetes try to eat about the same (reasonable) amount of carbohydrate around the same tune each day. In one aspect, the eating system may add a color-coding rule to help people understand which foods are higher or lower in carbohydrates. For example, foods with <10 g carbohydrate and/or <50% kcal from carbohydrate could be coded with a specific color score. While foods with ≧10 g of carbohydrate could be coded with a different color score or otherwise include a different intensity.

Alternatively, color coding could be assigned based on the percentage of calories coming from carbohydrate in a given food. For example, foods where 25% (or more) of their calories are coming from carbohydrate could be assigned one color, where foods with less carbohydrate calories would have a different color. The color coding ratio of the daily score can be changed to vary the percentage of carbohydrate in the diet from 0-100% in theory, but realistically within the commonly prescribed range of 40-65% calories from carbohydrates. Color coding could also be used to denote the number of carbohydrate choices that a food represents.

In one form, incorporation of a color coding rule could include the daily score being divided into two (or more) colors (e.g., green and blue). To help with distribution of the daily score throughout the day, the system can provide guidelines for the number of a particular color score used at each eating occasion. Scores would be scaled to reflect the desired daily macronutrient intake. Furthermore, the color coding may be dynamically controlled based on a food's compliance for the nutrient of concern target for a specific eating occasion or plan. In other words, the color for a particular food may appear a lighter blue for a breakfast occasion and darker for a dinner occasion because it is closer to the dinner target than the breakfast target.

Meal Planning

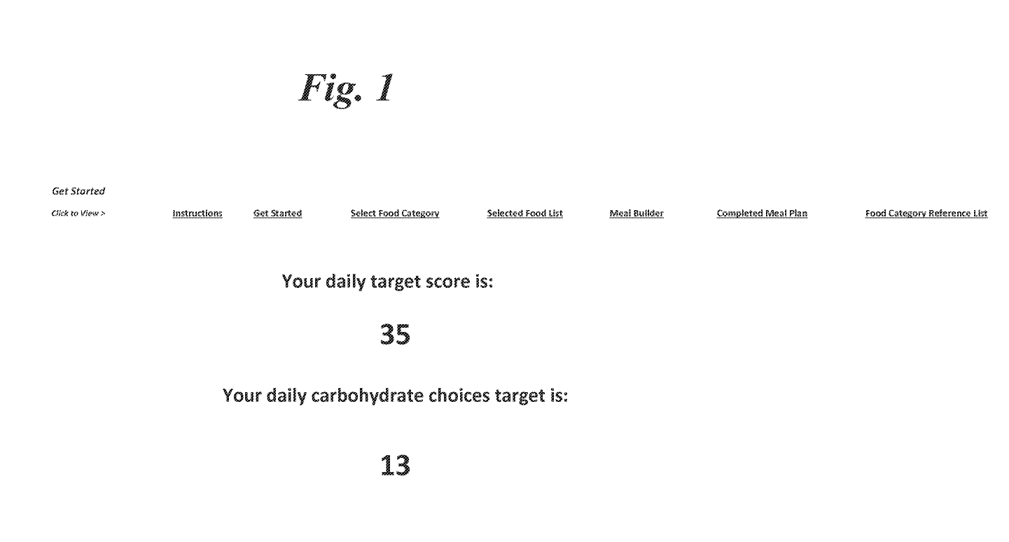

A system was created to facilitate tracking both a composite nutrition score representing nutrition quality, and also a key nutrient of concern. In one form, the system was implemented such as shown in the figures. By way of example, the system in FIG. 1 was setup to track carbohydrates as the nutrient of concern to facilitate menu planning for individuals with diabetes who use insulin. As seen in this figures, the target composite score for the day is 35 and the overall carbohydrate choice target would be 13.

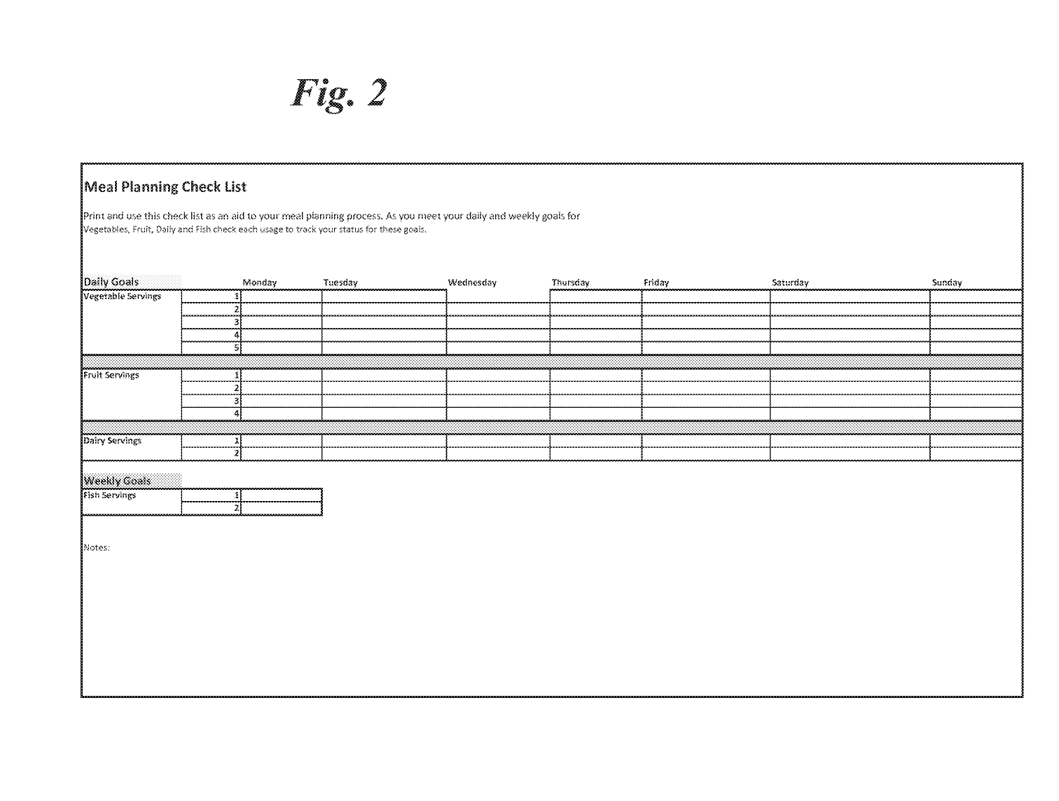

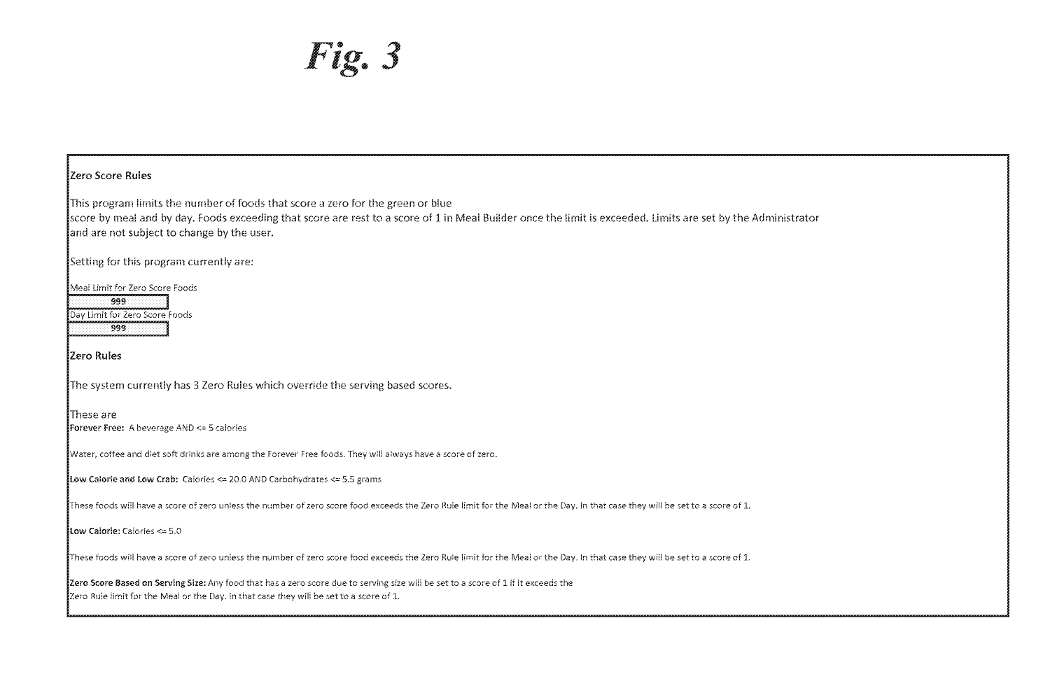

As shown in FIG. 2, a meal planning checklist may be included for a user to help prepare a weekly meal or otherwise may be filled in after the meal planning is complete so a user can readily see the plan. FIG. 3 illustrates that in some forms, certain foods may be considered zero score foods such that they do not add to the composite nutrition score and/or the nutrient of concern. The zero score foods may be adjusted for specific diets and/or specific nutrients of concern.

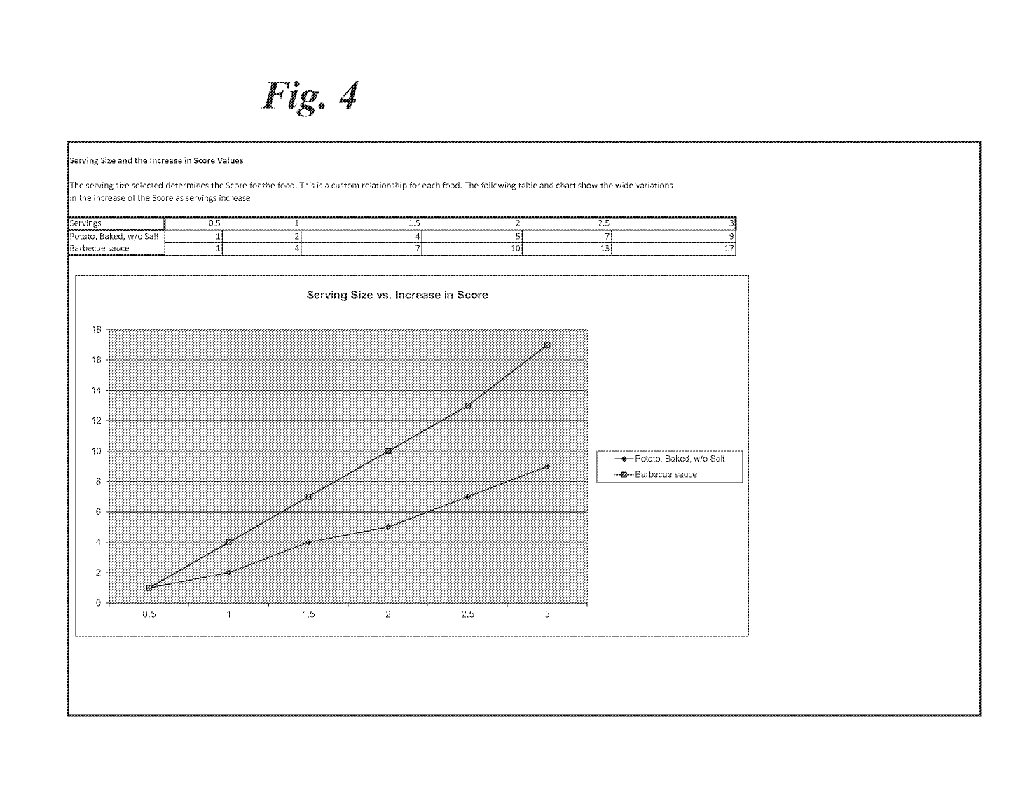

FIG. 4 illustrates that the serving size of certain foods have a different impact on the overall composite score and/or the nutrient of concern. In other words, two different foods may have the same composite score for 0.5 servings, but when you reach 3 servings, they have significantly different composite scores.

In this example, the algorithm score is tracked as the primary number, and colors are used to help the user identify food choices that best fit into the menu plan. Conditional formatting is used to apply the color to the relevant cells. A number of tabs may be used to assist in implementing the system and method as described below and found in the figures.

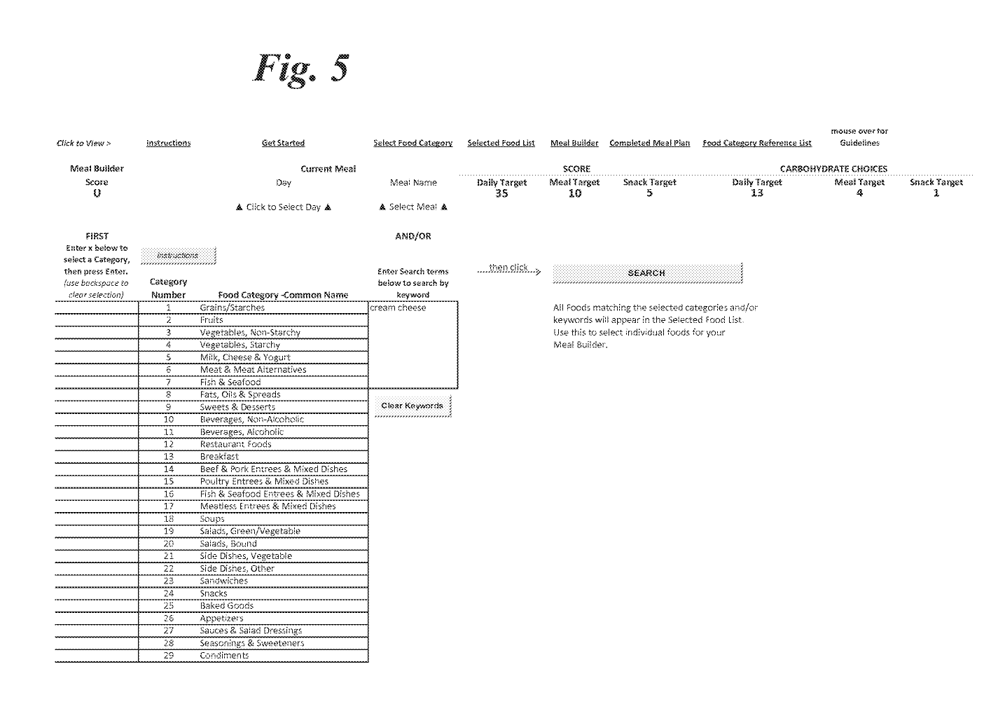

“Select Food Category” tab: The user selects the Day and Meal Name of the meal they would like to plan. They then choose a food category and/or enter a search keyword to narrow the search. After clicking the “Show Selected Foods” button, the results are displayed on the “Selected Foods List” tab. These features are shown in FIG. 5.

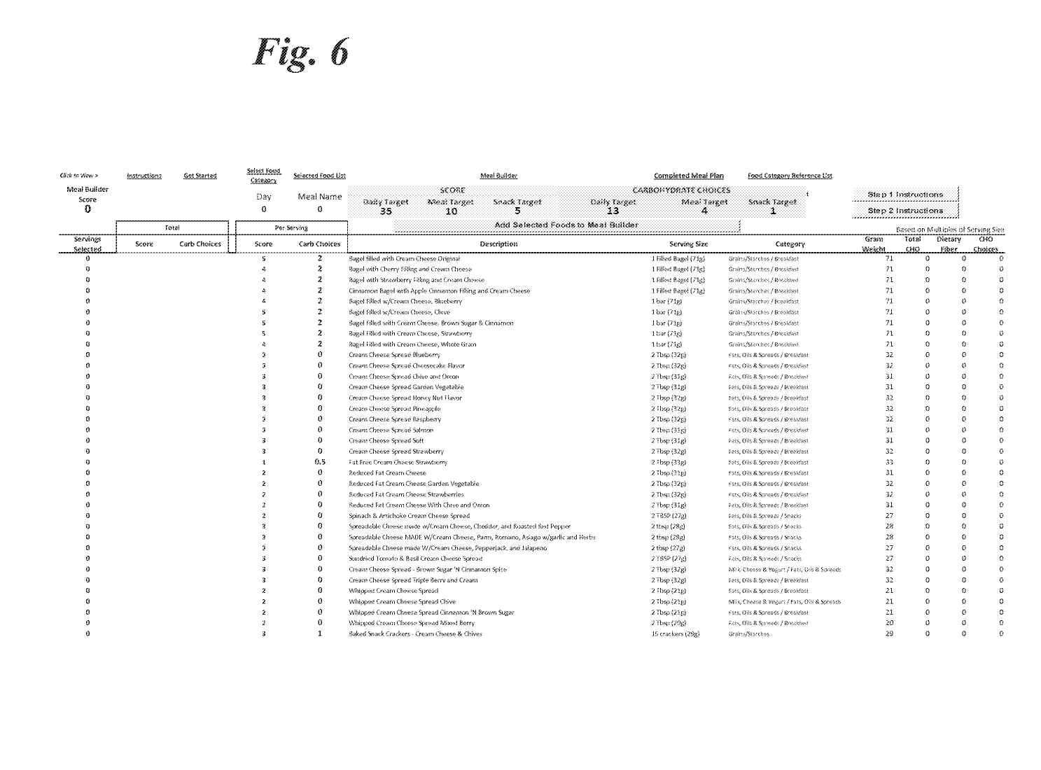

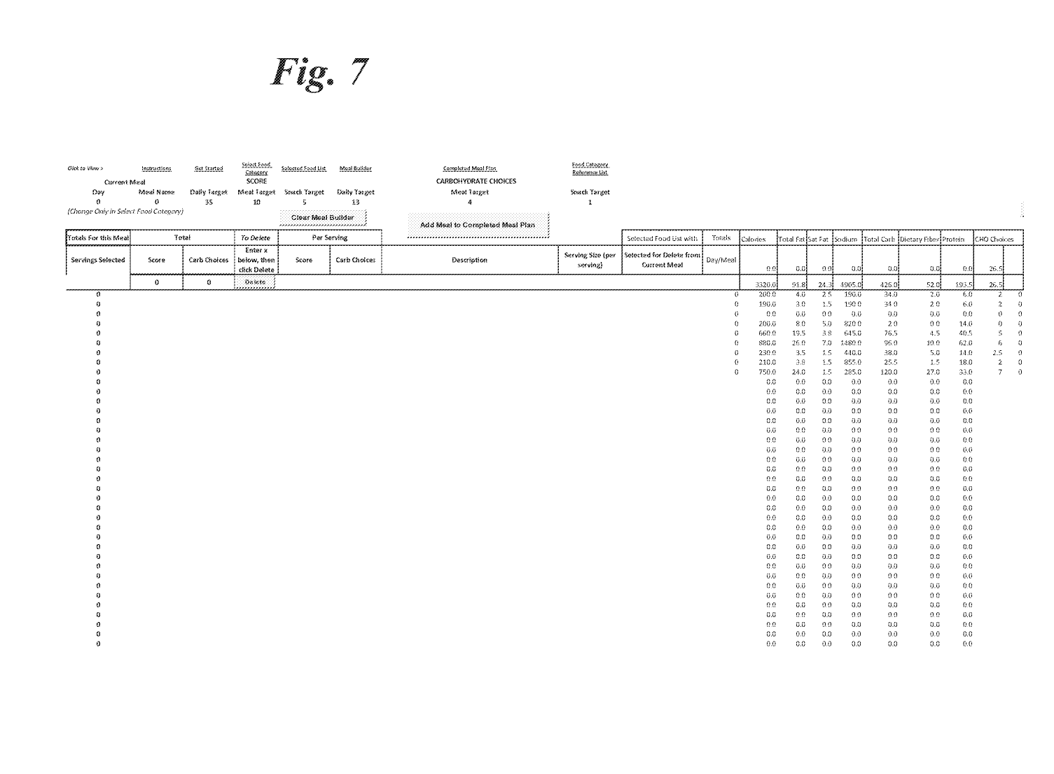

“Selected Foods List” tab: Color shading (luminosity) is applied to the set of search results to help the user find foods in the list that meet a carbohydrate choice criteria based on a single serving. Food servings are selected by choosing from the dropdown list next to each food in column A, then clicking the “Add to Meal Builder” button, These features are shown in FIGS. 6 and 7.

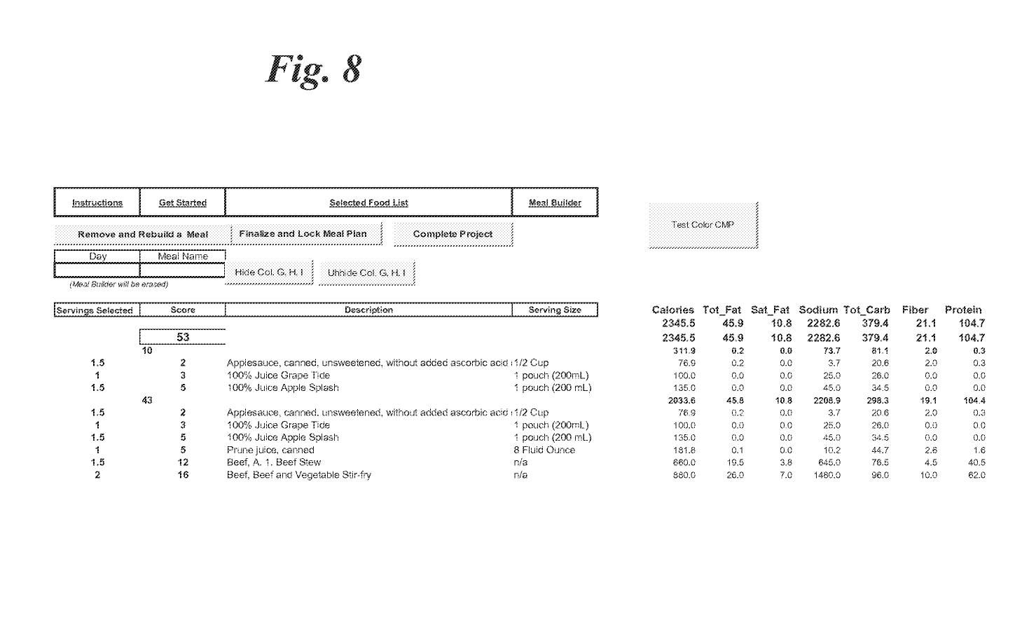

“Meal Builder” tab: The foods selected for the meal are displayed. Color shading (luminosity) is again used to indicate the number of CHO choices that come from each food, except this is now based on the number of servings selected. Color hue is used in the “CHO Choices” cell in the header row indicating the planned meal is below (blue), above (red) or on target (green) with the number of CHO choices required for their meal (cell F5). When the meal is planned, the user clicks the button “Add to Completed Meal Plan” and the meal entries are copied to the “Completed Meal Plan.” These features are illustrated in FIG. 8.

Repeating this process will generate daily or weekly meal plans that meet both a nutrition algorithm score per meal and also contain the required number of carbohydrate choices per meal. Such a system could also supply automatically-generated meal plans and narrow search results that only meet score and CHO choice criteria. The benefit of such a system is that it can facilitate the planning of a diet with good nutritional quality and also the required carbohydrate content by a non-professional user.

The system could alternatively identify foods that meet a particular target score and carbohydrate content by flagging them with a different color. Further still the system could filter search results to only display foods that would meet both target score and nutrient criteria. Finally, such a method could also be implemented as part of a “swap list” of foods that could be substituted for foods in an existing meal plan.

It should be understood that the system, method and device may be used so that varying amounts of servings may be selected. For example, a user may select 1.5, 2, 3, etc. servings of a particular comestible and the system will determine the composite score and indicia for the nutrient of concern for the selected servings. The user can then also make adjustments to the number of servings, which, in turn, may adjust the indicia for the nutrient of concern so that the nutrient of concern falls within the desired ranges. Additionally, multiple comestible selections may be combined and the system can provide an overall composite score and an overall indicia for the nutrient of concern. Further, in this form, the system can provide indicia for further food selections in view of the previously selected foods so a user can quickly determine if a further food selection would be appropriate in view of the overall previous selections. Similarly, meals can be selected whereby multiple comestibles can be combined into a meal to determine if the meal falls within acceptable ranges. Multiple meals can then be combined for overall scores for a day, week, etc.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method for determining a comestible's suitability for a nutrition program, the method comprising the steps of:
determining a plurality of nutritional attributes per serving for a comestible, the nutritional attributes selected from the group consisting of calories, fat, fiber, protein, salt, and carbohydrates;
calculating a composite score for the comestible based on the plurality of nutritional attributes, the composite score providing a quantitative indicator of the nutrition of the comestible;
determining an amount of a nutrient of concern per serving of the comestible;
comparing the amount of the nutrient of concern per serving to an overall intake limit of the nutrient of concern for the nutritional program to select an indicia from a range of indicia for the nutrient of concern; and
providing the composite score and the indicia for the nutrient of concern for the comestible.

2. The method of claim 1 wherein the indicia for the nutrient of concern for the comestible is a non-numeric indicia.

3. The method of claim 2 wherein the range of indicia for the nutrient of concern includes a plurality of colors and the indicia for the nutrient of concern for the comestible is one of the plurality of colors.

4. The method of claim 1 wherein the nutrient of concern is selected from the group consisting of carbohydrates, fats, potassium and sodium.

5. The method of claim 1 further comprising providing a supplemental indicia for a supplemental nutrient of concern.

6. A method for selecting foods suitable for a nutrition program, the method comprising the steps of:
by a control circuit:
receiving an identification of a first comestible and a number of servings of the first comestible from a user;
providing a first composite score reflecting a plurality of nutritional attributes for the first comestible for the number of servings;
providing a first indicia for a nutrient of concern, the first indicia representing the relative amount of the nutrient of concern in the first comestible compared to an overall intake limit of the nutrient of concern in the nutrition program;
receiving an identification of a second comestible and a number of servings of the second comestible from the user;
providing an overall composite score reflecting a total of the nutritional attributes for the number of servings of the first and second comestibles; and
providing an overall indicia for the nutrient of concern, the overall indicia representing the relative total amount of the nutrient of concern in the servings of the first and second comestibles compared to the overall intake limit of the nutrient of concern in the nutrition program.

7. The method of claim 6 wherein the first indicia and the overall indicia for the nutrient of concern for the comestible are non-numeric indicia.

8. The method of claim 7 wherein the range of indicia for the nutrient of concern includes a plurality of colors and each of the first indicia and overall indicia for the nutrient of concern for the comestible is one of the plurality of colors.

9. The method of claim 6 wherein the nutrient of concern is selected from the group consisting of carbohydrates, fats, potassium and sodium.

10. The method of claim 6 further comprising providing a supplemental indicia for a supplemental nutrient of concern.

11. The method of claim 6 further comprising providing a second indicia for the nutrient of concern, the second indicia representing the relative amount of the nutrient of concern in the second comestible.

12. The method of claim 6 further comprising providing a suggestion of at least one additional comestible and a number of servings of the at least one additional comestible to the user, the total amount of the nutrient of concern in the servings of the first comestible, the second comestible and the at least one additional comestible falling within an acceptable range for the nutrition program.

13. The method of claim 6 wherein the overall intake limit for the nutrient of concern is a limit for one of the group consisting of a meal, a day or meals and a week of meals.

14. A method for selecting foods suitable for a nutrition program, the method comprising the steps of:
by a control circuit:
receiving an identification of a first comestible and a number of servings of the first comestible from a user;
providing a first composite score reflecting a plurality of nutritional attributes for the first comestible for the number of servings;
providing a first indicia for a nutrient of concern, the first indicia representing the relative amount of the nutrient of concern in the first comestible compared to an overall intake limit of the nutrient of concern in the nutrition program;
providing a suggestion of at least one additional comestible and a number of servings of the at least one additional comestible to the user, the total amount of the nutrient of concern in the servings of the first comestible and the servings of the at least one additional comestible falling within an acceptable range for the nutrition program;
providing an overall composite score reflecting a total of the nutritional attributes for the number of servings of the first comestibles and the at least one additional comestible; and
providing an overall indicia for the nutrient of concern, the overall indicia representing the relative total amount of the nutrient of concern in the servings of the first and second comestibles compared to the overall intake limit of the nutrient of concern in the nutrition program.

15. The method of claim 14 wherein the first indicia and the overall indicia for the nutrient of concern for the comestible are non-numeric indicia.

16. The method of claim 15 wherein the range of indicia for the nutrient of concern includes a plurality of colors and each of the first indicia and overall indicia for the nutrient of concern for the comestible is one of the plurality of colors.

17. The method of claim 14 wherein the nutrient of concern is selected from the group consisting of carbohydrates, fats, potassium and sodium.

18. The method of claim 14 further comprising providing a supplemental indicia for a supplemental nutrient of concern.

19. The method of claim 15 further comprising providing a second indicia for the nutrient of concern, the second indicia representing the relative amount of the nutrient of concern in the at least one additional comestible.

20. The method of claim 14 wherein the overall intake limit for the nutrient of concern is a limit for one of the group consisting of a meal, a day or meals and a week of meals.

21. The method of claim 14 wherein an entire meal is suggested to the user, the total amount of the nutrient of concern in the meal falling within an acceptable range for the nutrition program.
